(19) United States
(12) Patent Application Publication
(10) Pub. No.: US 2005/0082492 A1
(43) Pub. Date: Apr. 21, 2005

(54) Image detector with tandem-gate TFT

(76) Inventors: Wei-Chuan Lin, Taipei City (TW); Kei-Hsiung Yang, Taoyuan Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/965,404

(22) Filed: Oct. 14, 2004

Related U.S. Application Data
(60) Provisional application No. 60/512,455, filed on Oct. 17, 2003.

(51) Int. Cl. G01T 1/24

(52) U.S. Cl. 250/370.14

(57) ABSTRACT

An X-ray image detector with a tandem-gate TFT. A storage capacitor comprises a bottom conductive layer connected to a ground line, and a top conductive layer insulated from the bottom conductive layer by an insulating layer. A thin film transistor controls release of the electric charge stored in the storage capacitor, wherein the thin film transistor comprises two electrically connected in series channel regions.

### CROSS REFERENCE TO RELATED APPLICATION

This application claims the full benefit and priority of provisional U.S. Patent Application Ser. No. 60/512,455, filed Oct. 17, 2003, entitled “A Tandem-Gate TFT Array With Low Leakage Current For Electromagnetic Imaging Device”, inventor Wei-Chuan Lin and Kei-Hsiung Yang, and incorporates the entire contents of said application herein.

### BACKGROUND

The invention relates to an X-ray image detector, and more particularly to an X-ray image detector fabricated utilizing a Thin Film Transistor (TFT) array process.

The use of two-dimensional arrays of thin film transistors (TFTs) for radiation detection is well known in the art. An exemplary X-ray imaging detector has been developed by L. E. Antonuk, J. Boudry, W. Huang, D. L. McShan, E. J. Morton, J. Yorkston, M. J. Longo, and R. A. Street, Demonstration of megavoltage and diagnostic X-ray imaging with hydrogenated amorphous silicon array, and referenced in MED. PHYS 19, 1455 (1992). In this related art detector, a scintillation material (e. g., phosphor screen or Csl) converts X-rays directly into light. The light then makes an impression on and is partially absorbed by an array of a-Si:H photodiodes that convert the absorbed light into charge in an amount proportional to the absorbed light. The light-generated charges are stored on a storage capacitor and read out through an adjacent thin film transistor (TFT) as each line of the detector array is addressed.

Another exemplary detector developed by W. Zhao and J. S. Rowland is the X-ray imaging using amorphous selenium (XRIASE), and referenced in MED. PHYS 22, 1595 (1995). In this detector, the X-rays make an impression on a selenium layer that converts the absorbed X-ray directly into charges. The generated charges are stored on a storage capacitor and read out through an adjacent thin film transistor (TFT) as each line of the detector array is addressed. Both the foresaid devices require charge measurement (or integrated current), proportional to the X-ray intensity for each addressed row of the array. The signal-to-noise ratio of both the foresaid devices is, ideally, proportional to the ratio of the generated charges to the noise-equivalent charges of the readout electronics. In practice, some of the generated charges will leak through the off-state TFT responsible for readout.

FIG. 1 is a schematic cross-sectional view illustrating the structure and operation of X-ray image detector 101 which comprises lower substrate 1, thin film transistor 3, storage capacitor 10, pixel electrode 12, photoconductive film 2, protection film 20, conductive electrode 24 and high voltage D.C. (direct current) power supply 26.

Photoconductive film 2 produces internal electric signals, i.e. pairs of electron (e) and holes (h), in proportion to the strength of external signals such as incident electromagnetic waves or magnetic waves. Photoconductive film 2 enable detection and conversion of external signals, particularly X-rays, and convert them to electric signals. Electron-hole pairs (6) are gathered in the form of electric charges at pixel electrode 12 located beneath the photoconductive film 2 by a voltage (E.sub.v) applied to conductive electrode 24 by the high voltage D.C. power supply 26, and is then stored in storage capacitor 10 formed in connection with a grounded common electrode externally. Charges stored in the storage capacitor 10 are transferred by TFT 3, controlled externally, to an external image display device for presentation of X-ray images.

To detect and convert X-ray signals into electric charges, in an x-ray image detector the number of electric charges trapped in the photoconductive film 2 must be decreased in a non-vertical direction by means such as applying a high voltage (more than 10 V/.mu.m) in the vertical direction between conductive electrode 24 and pixel electrode 12.

Electric charges in the photoconductive film 2 produced by X-ray energy are trapped and gathered on a protective film (not illustrated), which protects the channel part of the TFT 3, as well as on the pixel electrode. The trapped and gathered electric charges induce charge into the channel region in the upper part of TFT 3, producing a high leakage current even when TFT 3 is in an “off” state, thus inhibiting switching operation of TFT 3.

Accordingly, a leakage current of a TFT in the off-state is a critical parameter determining the overall image quality of the radiation image for a constant X-ray input flux. To reduce the leakage current of a single-gate TFT in the off-state, special and delicate process treatments are typically required after formation of the semiconductor channel. The process window for such special treatment is typically narrower and results in either high or poor uniformity in TFT leakage current in the off-state.

### SUMMARY

Embodiments of the invention achieve technical advantages by using tandem-gate TFTs in an image detector.

In accordance with an embodiment of the invention, a thin film transistor with a tandem-gate is disclosed. First and second gate electrodes are disposed on a substrate. A gate insulating layer covers the first and second gate electrodes and the glass substrate. First and second active islands comprising first and second channel regions respectively are disposed on the gate insulating layer. A floating electrode electrically connects the first and second channel regions.

In accordance with an embodiment of the invention, an X-ray image detector with a tandem-gate TFT is disclosed. A storage capacitor comprises a bottom conductive layer connected to a ground line, and a top conductive layer insulated from the bottom conductive layer by an insulating layer. A thin film transistor controls release of the electric charges stored in the storage capacitor, wherein the thin film transistor comprises two electrically connected in series channel region.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic cross-sectional view illustrating the structure and operation of an X-ray image detector;

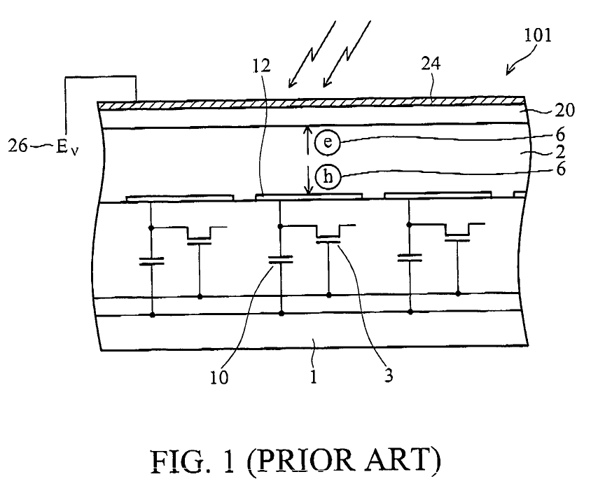

FIG. 2 depicts the scheme of a pixel layout of a XRIASE type X-ray image detector;

FIG. 3 describes a cross-sectional view of the TFT shown in FIG. 2;

FIG. 4 shows the cross-sectional view of a tandem-gate TFT of an embodiment of the invention;

FIG. 5 shows the leakage current of the tandem-gate TFT of an embodiment of the invention in the off-state;

FIG. 6 shows the top-view of a pixel layout of an embodiment of the invention.

### DETAILED DESCRIPTION

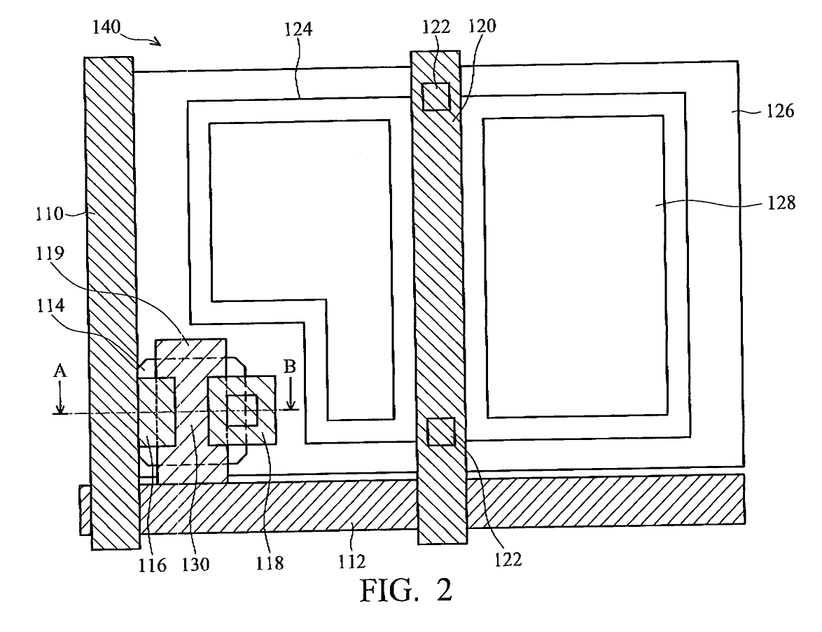

The two-dimensional arrays of thin film transistors (TFTs) for radiation detection typically comprises a switching or isolation device such as a TFT associated with each element or pixel to permit individual pixels in the imager to be selectively addressed. FIG. 2 depicts the scheme of a pixel layout 140 (XRIASE) of an x-ray image detector know to the inventor. This is not prior art for the purpose of determining the patentability of the present invention. The x-ray image detector illustrated in FIG. 2 consists of a gate addressing line 112, a data line 110, a ground line 120, a bottom conductive (indium-tin oxide) layer 124 connected to the ground line 120 through a via hole 122, a top conductive (indium-tin oxide) layer 126 insulated from the bottom conductive layer 124 by an insulating layer or layers, and the bottom-gate TFT.

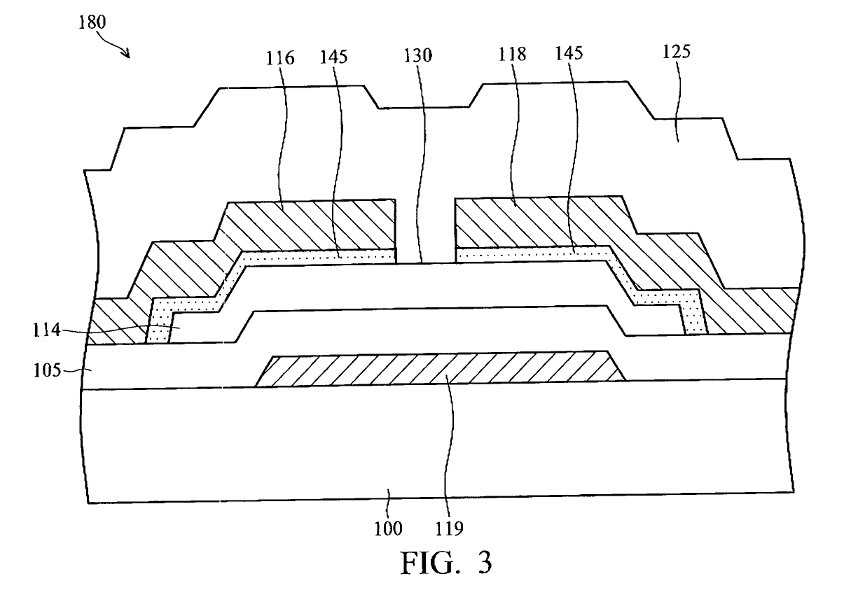

The structure of a bottom-gate TFT associated with each imaging element or pixel typically includes a source electrode 116 connected to the data line 110, a drain electrode 118 connected to the top conductive layer 126 through a via hole 122, a gate electrode 119 connected to the gate line 112, and an island of thin-film amorphous silicon (a-Si:H or other semiconductor material) 114 electrically isolated from the gate electrode 119. A TFT channel 130 (part of amorphous silicon island 114) exists between the source electrode 116 and the drain electrode 118. The gate electrode 119 is placed directly below the channel 130 with an electrically insulated layer (gate extremely low leakage current. The TFT 180 illustrated in FIG. 3, however, cannot provide extremely low leakage current in the off-state, thus good image quality of the radiation imager does not achieve.

Embodiments of the invention introduces a tandem-gate TFT to reduce the leakage current thereof in the off-state with a large process window for good uniformity across the entire TFT-array.

Embodiments of the invention further provide improved signal-to-noise ratio of both the foresaid devices by reducing the leakage current through the off-state TFT. One advantage of a higher signal-to-noise ratio is the reduction of X-ray dosage on a receiving patient so as to reduce the risk of X-ray exposure. The other advantage improved image quality which enables better diagnostic accuracy for the images derived from the X-ray detector based on both the foresaid devices.

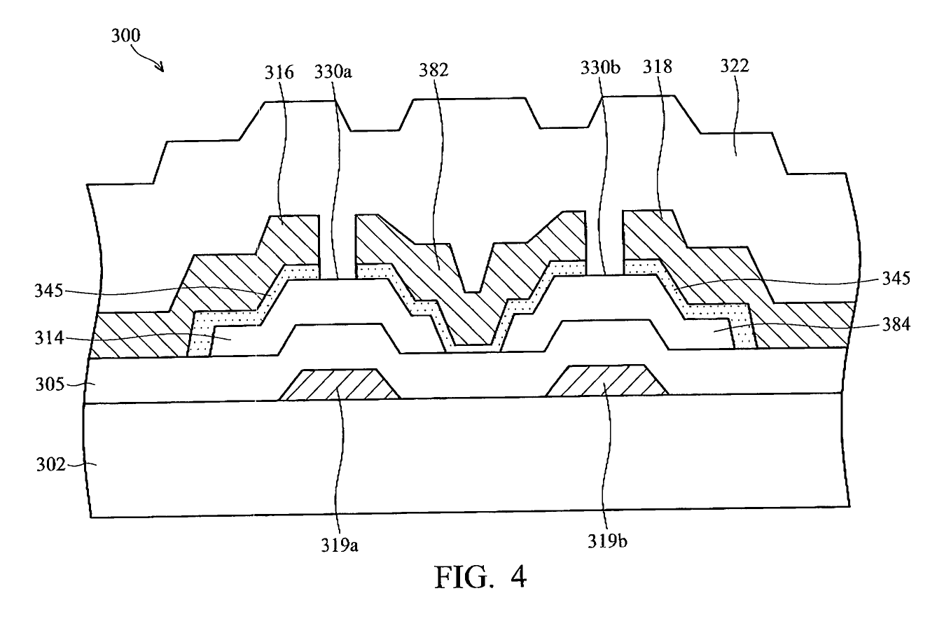

FIG. 4 depicts a cross-sectional view 300 of a tandem-gate TFT of an embodiment of the invention for reducing the leakage current of the TFT in the off state. The structure of the tandem-gate TFT 300 shown in FIG. 4 is different from that of a single-gate TFT 180 shown in FIG. 3. The stripe of the gate electrode 119 shown in FIG. 3 is now split into two stripes 319a and 319b shown in FIG. 4. The channel region 130 shown in FIG. 3 is now split or enlarged into two regions includes 330a and 330b, where the channels 330a and 330b are corresponding to the stripe gate electrodes 319a and 319b respectively.

Two thin films, comprising a doped amorphous silicon layer (n+ amorphous silicon layer) 345 and a floating electrode 382, are deposited in sequence and patterned on top of the channel region. The function of the tandem-gate TFT, as shown in FIG. 4, can be approximately divided into two bottom-gate transistors, TFT1 and TFT2, with their gate electrodes 319a and 319b connected in parallel but their channel regions 330a and 330b connected in series through a floating electrode 382. The floating electrode 382 simultaneously serves as the drain electrode for TFT1 and the source electrode for TFT2.

In FIG. 4, the in-plane horizontal distance is defined as length and the vertical distance as thickness. The sequence of fabrication steps involved in a four or five mask fabrication of bottom gate a-Si TFTs. Typically, a non-alkaline glass is used as the glass substrate 302 (e.g. 0.5 mm, 0.63 mm, 0.7 mm). After a glass substrate 302 has been chemically cleaned in an ultrasonic bath, a metal layer (e.g. Cr, Mo/Ta, AINd/Mo, MoW, Ti, Ti—Mo, Ta) with a total thickness of below 500 nm is deposited by DC magnetron sputtering and then chemically wet etched to form the gate electrodes 319a and 319b. The lengths of the gate electrodes 319a and 319b are approximately the same and equal to or larger than the corresponding lengths of the channel 330a and 330b ranging from 5 um to 20 um. The next three layer are deposited by PECVD (Plasma Enhanced Chemical Vapor Deposition) and dry etched by PE (plasma Etching) or RIE (Reactive Ion Etch) to form the pattern for a first active island 314 and a second active island 384 of the TFT, each comprising a source region, a channel region and a drain region.

The gate-insulator layer 305 with a thickness of about 100 to 800 nm typically comprises silicon nitride or silicon oxide or silicon oxynitride or multi-layers of the mentioned materials. The first and second active islands 314 and 384 are deposited by PECVD with silane gas (SiH4) and hydrogen diluting gas, which has a typical thickness from 50 to 500 nm and serve as a semiconductor. The doped amorphous silicon layer 345 is deposited with silane gas, hydrogen diluting gas and a doping gas such as phosphine or diborane, which has a typical thickness from 30 to 100 nm as a layer providing an ohmic contact for drain and source. In the active islands 314 and 384, dangling bonds are neutralized by hydrogen atoms, resulting in enhanced electron mobility to values from 0.5 cm²/Vs to 1 cm²/Vs. A metal layer (e.g. Cr, Cr/Al/Cr, Mo/Ta, Mo/Al/Mo) each with a total thickness of below about 500 nm is sputtered and chemically wet etched to form the drain electrode 318, source electrode 316 and the floating electrode 382. The floating electrode 382 electrically connects the channel region of the first and second active islands 314 and 384.

The pattern of metal serves as a mask for plasma etching of N+ amorphous silicon to remove all residues thereof while leaving active islands 314, and 384 with a homogeneous thickness of around below 200 nm. The lengths of channel 330a and 330b are 1 to 10 microns, and the length of the metal 382 is 5 to 50 microns. Finally, a dielectric passivation layer of SiNₓ 322 with a typical thickness from 100 to 1000 nm is deposited thereon for protecting the electrodes.

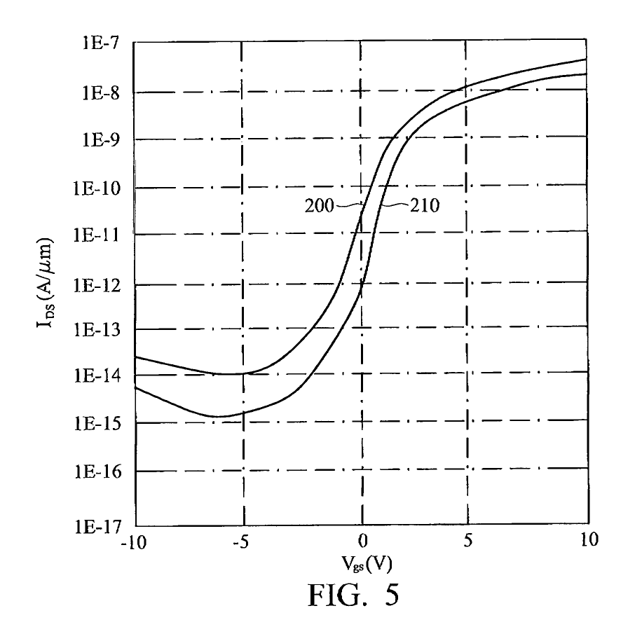

In FIG. 5, the curves 200 and 210 show the experimental results of an embodiment of the invention on the current, I_{DS} (in unit of amperes per micron-width of TFT channels) between the source and drain electrodes verses V_{gs}, the voltage between the gate and source electrodes, for a single-gate TFT and a tandem gate TFT, respectively. The experimental results shown in FIG. 5 indicates that the leakage current of the tandem-gate TFT is approximately one order of magnitude lower than that of the single-gate TFT when the Vgs is from 0 to −10 V and VDS=10 V (TFT in the off-state).

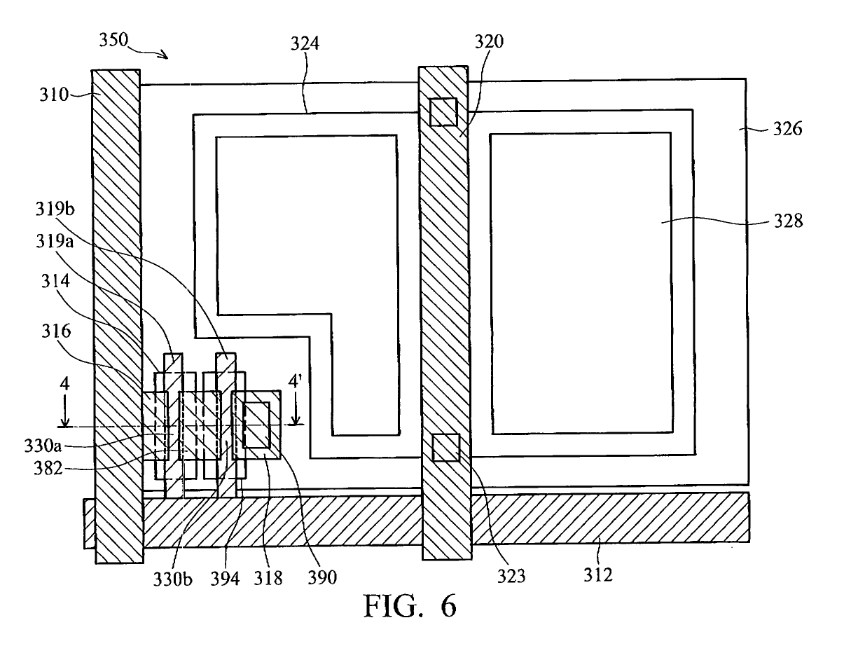

FIG. 6 shows the top-view of a pixel layout that includes the tandem-gate TFT (the cross-sectional view along line 4-4′ is shown in FIG. 4). FIG. 6 includes a data line 310, a gate line 312, a ground line 320, and two conductive layers (e.q., indium-tin oxide) layers 326 and 324 to form a storage capacitor. The bottom conductive layer (e.q., indium-tin oxide) layer 324 is connected to the ground line 320 through a via hole 323, and a top conductive layer (e.q., indium-tin oxide) layer 326 is insulated from the bottom conductive layer 324 by an insulating layer and the tandem-gate TFT. In this embodiment, the top and bottom conductive layers are preferably transparent conductive layers, for example ITO, to provide a good transmittance for the x-ray imager.

The structure of a tandem-gate TFT associated with each imaging element or pixel is illustrated in FIG. 6. A source electrode 316 is connected to the data line 310, and a drain electrode 318 is connected to the top conductive layer 326 through a via hole 390. First and second gate electrodes 319a and 319b are connected to the gate line 312. First and second active islands of thin-film amorphous silicon (a-Si:H or other semiconductor material) 314 and 394 are electrically isolated from the first and second gate electrodes 319a and 319b respectively. A first TFT channel 330a (part of amorphous silicon island 314) is disposed between the source electrode 316 and the floating electrode 382, and a second TFT channel 330b (part of the second amorphous silicon island 394) is disposed between the floating electrode 382 and the drain electrode 318.

The first and second gate electrodes 319a and 319b are placed directly below the first and second channels respectively with an electrically insulated layer (gate insulator) (not shown here) placed between the gate electrodes 319a and 319b and the amorphous silicon island 314 and 394 The top conductive layer 326 is electrically isolated from the gate line 312, the data line 310, and the ground line 320. The charges stored in the top conductive layer 326 can be detected by a peripheral circuit (not shown here) connected to the data line 310 by turning the first channel 330a or second channel 330b into a conductive state.

The parameters for obtaining the curve 210 of FIG. 5 are as follows. The gate electrodes 319a and 319b have approximately the same length of about 5˜10 microns and are made of Mo/Al(Nd)/Mo, and a tri-layer metal film with a total thickness of about 330 nm. The insulator layer 305 was made of silicon nitride film with a thickness of about 300 nm. The amorphous silicon island 314 is made of an intrinsic amorphous silicon film with a thickness of about 120 to 200 nm. The n+ amorphous silicon layer 345 has a thickness of about 50 nm. The channels 330a and 330b have approximately the same length of about 5 microns and approximately the same thickness of about 70 to 150 nm. The floating electrode 382 has a length of about 5-10 microns. The source electrode 316, the drain electrode 318, and the floating electrode 382 are made of Mo/Al(Nd)/Mo or Mo/Al/Mo, a tri-layer metal film with a total thickness of about 330 nm.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of thee appended claims should be accorded the broadest interpretation so as to encompass all such modifications and similar arrangements.

1. A tandem-gate thin film transistor, comprising:
a first and a second gate electrode disposed on a substrate;
a gate insulating layer covering the first and the second gate electrodes and the substrate;
a first and a second active island comprising a first channel region and a second channel region respectively disposed on the gate insulating layer; and
a floating electrode electrically connecting the first and second channel regions.

2. The tandem-gate thin film transistor as claimed in claim 1, wherein the substrate is a glass substrate.

3. The tandem-gate thin film transistor as claimed in claim 1, further comprising a source electrode partially disposed over the first active island, and a drain electrode partially disposed over the second active island.

4. The tandem-gate thin film transistor as claimed in claim 1, further comprising a doped amorphous silicon layer interposed between the first and second active islands, and the source electrode, the floating electrode and the drain electrode.

5. The tandem-gate thin film transistor as claimed in claim 3, further comprising a dielectric passivation layer covering the source electrode, the floating electrode and the drain electrode.

6. The tandem-gate thin film transistor as claimed in claim 1, wherein the first and second gate electrodes have approximately the same length.

7. An X-ray image detector, comprising:
a ground line;
a storage capacitor comprising a bottom conductive layer connected to the ground line, a top conductive layer insulated from the bottom conductive layer by an insulating layer; and
a thin film transistor controlling release of electric charges stored in the storage capacitor, wherein the thin film transistor comprises two electrically connected in series channel regions.

8. The X-ray image detector as claimed in claim 7, wherein the two channel regions comprise a first channel region and a second channel region, and the thin film transistor further comprises:
a first and a second gate electrode disposed on a substrate;
a gate insulating layer covering the first and the second gate electrode and the substrate;
a first and a second active island comprising the first and the second channel region respectively disposed on the gate insulating layer;
a source electrode partially disposed over the first active island;
a drain electrode partially disposed over the second active island; and
a floating electrode electrically connecting the first and second channel regions.

9. The X-ray image detector as claimed in claim 8, further comprising a data line connecting to the source electrode.

10. The X-ray image detector as claimed in claim 8, further comprising a gate line connecting the first and second gate electrodes.

11. The X-ray image detector as claimed in claim 8, wherein the drain electrode is connected to the top conductive layer through a second via hole.

12. The X-ray image detector as claimed in claim 8, wherein the floating electrode is disposed partially over the first and second active islands, and between the source electrode and the drain electrode.

13. The X-ray image detector as claimed in claim 8, wherein the source, drain and floating electrodes are formed by defining a same conductive layer.

14. The X-ray image detector as claimed in claim 7, wherein the bottom conductive layer is connected to the ground line through a first via hole.

15. The X-ray image detector as claimed in claim 7, wherein the top and bottom conductive layers comprise ITO.

16. A tandem-gate thin film transistor, comprising:
a first bottom-gate transistor having a first channel; and
a second bottom-gate transistor having a second channel adjacent to the first bottom-gate transistor, wherein a floating electrode is disposed between the first bottom-gate transistor and the second bottom-gate transistor, and electrically connects the first channel and the second channel to serve as a drain electrode of the first bottom-gate transistor, and a source electrode of the second bottom-gate transistor.

17. The tandem-gate thin film transistor as claimed in claim 16, wherein the first and second bottom-gate transistors further comprise:
a first and a second gate electrode disposed on a substrate;
a gate insulating layer covering the first and the second gate electrode and the substrate;
a first and a second active island comprising the first and the second channel region respectively disposed on the gate insulating layer;
a source electrode partially disposed over the first active island; and
a drain electrode partially disposed over the second active island.

18. The tandem-gate thin film transistor as claimed in claim 17, wherein the floating electrode is disposed partially over the first and second active islands, and between the source electrode and the drain electrode.

19. The tandem-gate thin film transistor as claimed in claim 17, wherein the source, drain and floating electrodes are formed by defining a same conductive layer.
